(19) United States
(12) Patent Application Publication
(10) Pub. No.: US 2014/0360010 A1
(43) Pub. Date: Dec. 11, 2014

(54) BATTERY SYSTEM FOR ELECTRICAL DEVICES

(71) Applicant: INTERNATIONAL BUSINESS MACHINES CORPORATION, Armonk, NY (US)

(72) Inventors: Walter Haug, Herrenberg (DE); Stefan Letz, Markranstaedt (DE); Roland Seiffert, Herrenberg (DE)

(21) Appl. No.: 14/466,251

(22) Filed: Aug. 22, 2014

Related U.S. Application Data
(63) Continuation of application No. 14/259,852, filed on Apr. 23, 2014.

(30) Foreign Application Priority Data
May 3, 2013 (GB) 1308000.7

(51) Int. Cl. H01M 2/02

(52) U.S. Cl. CPC H01M 2/024
USPC 29/623.1

(57) ABSTRACT

A method for loading electrical vehicles with batteries may be provided. The battery system may comprise a battery container with an inlet channel for a serially inserting multiple batteries with substantially identical shape into the battery container, and a battery holder with a holding mechanism to selectively hold the inserted battery. For each of the battery holders, electrical connectors for connecting the inserted batteries may be available. An ejection may be possible via an outlet channel and an ejection mechanism.

The present application is a continuation application of, and claims priority to, a U.S. patent application of the same title, Ser. No. 14/259,852, Attorney Docket No. DE920130003US1, which was filed on Apr. 23, 2014, assigned to the same assignee, and incorporated herein by reference in its entirety.

### FIELD OF THE INVENTION

The invention relates generally to a method for loading a battery container.

### BACKGROUND OF THE INVENTION

E-mobility is en vogue these days. Several technologies have been tested. Some concepts are based on electrical fuel cells. Most existing approaches for e-mobility are based on rechargeable batteries. However, batteries are a critical part of e-mobility concepts. Batteries wear out and are the most expensive part of e-cars or other electrical vehicles. Additionally, batteries have a limited life-span. If combined in packs, not all battery elements within the package age with the same speed. Thus, batteries with different remaining life time may be included in the same battery pack. Moreover, batteries feature hard requirements for packaging and cooling, especially, if packed together in large battery packs. Besides, large battery packs are heavy, difficult to handle and vehicles have to be designed around the battery packs. This means for e-vehicle manufacturers that they are pretty restricted when designing a vehicle.

Hence, existing electric vehicle battery solutions have a large number of drawbacks. If batteries are not swapped in and out of the vehicle, they need to be charged inside the vehicle. This may take a very long time—too long for a driver used to traditional gas based refueling cycles. Thus, if batteries may be charged within the vehicle, this is not really compatible with today's gas station infrastructure. As mentioned above already, the form and size of batteries today contain the vehicle construction. Standard form factors for batteries are not in sight. Every battery manufacturer is introducing its own concept and shape of batteries. At the end of a life cycle of battery packs the complete packs have to be recycled. Individual cells may not be handled independently. For some of the addressed problems partial solution may have been found. Certain prior art discloses a removable battery circuit system for recharging electrical vehicles at charging stations. The motor vehicles comprise each a plurality of identical removable batteries which the user can exchange. A control device selectively controls the extraction of energy from the removable battery modules, such that the removable battery modules are individually discharged in series or groups.

Certain prior art discloses a system for a swappable battery pack for an electric vehicle. Each battery pack unit comprises a battery compartment housing, a battery carrier track which is slidable within the battery compartment housing via at least one linear actuator. The battery carrier rack also contains a plurality of modular battery packs nested into its docking enclosures. In order to transfer or swap the modularized battery packs, the slidable battery carrier rack must project out from its compartment in a predetermined direction and distance and then the nested modularized battery packs can be detached from its docking enclosures.

However, none of the proposed partial solution has a complete solution for existing drawbacks of refueling a vehicle's batteries. Thus, it is an objective of the current invention to overcome the limitations of existing solutions and, in particular, to overcome limitations related to battery modules of multiple batteries in battery packs and disadvantages related to design freedom for related e-vehicles and handling and exchange of large and heavy battery packs.

### SUMMARY OF THE INVENTION

This need may be addressed by a method for refueling an electrical device according to the independent claims.

According to one embodiment, a battery system for an electrical device may be provided. The battery system may comprise a battery container comprising an inlet channel for serially inserting multiple batteries into the battery container. The batteries may be of identical shape.

The battery system may also comprise a battery holder, and in particular a plurality of battery holders for the inserted batteries. Each battery holder may comprise a holding mechanism—in particular a clamp or lock mechanism—that may be operable by applying an operation trigger to selectively hold inserted batteries. Each of the battery holders may comprise electrical connectors for connecting the inserted batteries, in particular to an electrical circuitry of the device.

Furthermore, the battery system may comprise an outlet channel, in particular linked to the battery container, for ejecting—in particular for a secure and controlled ejection—batteries out of the battery container.

Additionally, the battery system may comprise an ejection mechanism to eject serially the batteries via the outlet channel. Such an ejection may, in particular, be performed using compressed air, or simply gravity using an aslope ramp.

Additionally, a battery, having a spherical shape may be provided. The battery may have two electrical terminals, wherein each of the two terminals may have a half-sphere shape on the surface of the spherical shape of the battery. The half-sphere shaped terminals may be positioned opposite to each other on the surface of the spherical shape of the battery. They may not be in contact with each other because the two half-sphere shaped terminals may be separated from each other by an isolator in the surface of the sphere.

It may be noted that more than two terminals may be possible which may be connected pair-wise to each other such that always two terminals correspond to a plus and a minus terminal.

Also, a battery loading system for spherical batteries may be provided. It may be equivalent to a gasoline pump in traditional car refueling systems for fueling cars with gasoline. The battery loading system may comprise a tube element having an inner diameter corresponding to the spherical batteries. The tube element may be attached to—in particular side-by-side—a second tube element for compressed air. A battery dispenser—comparable to a gas pump nozzle in traditional gasoline refueling systems—may be adapted for being connected to a device to which the batteries are to be loaded. The battery loading system may also comprise a first box for charged batteries, and a second box for receiving discharged batteries. A vent may give alternative way for the charged batteries or the discharged batteries.

It may be noted that the tube element may as well be a flexible pipe which may be robot-operated.

According to another embodiment, a method for loading or refueling—in the sense of refurbishing or re-loading or re-equipping—an electrical device with batteries may be provided. The method may comprise inserting multiple batteries having an identical shape into a battery container which may comprise an inlet channel for a serial insertion of multiple batteries. The method may also comprise selectively holding each of the inserted batteries with a battery holder—in particular, a clamp mechanism—that is operable by applying an operation trigger. The inserted batteries may be connected to electrical connectors, and the batteries may be ejected serially out of the battery container through an outlet channel.

According to an additional embodiment, a device—e.g. an electrically motorized vehicle—may be disclosed comprising the battery refueling system.

In a typical car using the inventive battery concept, the batteries may have a size about equivalent to a tennis ball. Larger movable devices may have larger spherical batteries. Smaller portable electrical devices may have smaller electrical, spherical batteries.

### BRIEF DESCRIPTION OF THE DRAWINGS

Preferred embodiments of the invention will now be described, by way of example only, and with reference to the following drawings:

FIG. 1 shows a block diagram of an embodiment of the inventive battery system.

FIG. 2 shows a block diagram of an embodiment of a device with an inlet channel and an outlet channel.

FIG. 3 shows a block diagram of an embodiment of a spherical battery with a holding mechanism.

FIG. 4 shows a block diagram of an embodiment of the battery loading system.

FIG. 5 shows an embodiment of the method for refueling an electrical device with batteries.

FIG. 6 shows an exemplary flow chart for refueling a vehicle with batteries.

FIG. 7 shows an exemplary flowchart for a recycle system for the batteries.

### DETAILED DESCRIPTION

A couple of things may be noted in light of the claimed subject-matter.

Instead of just one battery holder, there may be a plurality of battery holders for each of the inserted batteries. However, it may not be required that each battery holder may be equipped with batteries. The battery container may only be partially loaded. The inserted batteries may be connected to an electrical circuitry which may be part of the electrical device. Electrical and electronic components may be provided to control a connection of the batteries to the electrical power system of the device.

The outlet channel may be adapted for a serial, secure and controlled removing of the batteries from the device. The outlet channel may allow unloading the batteries using compressed air. Alternatively, the outlet channel may just have an opening such that the batteries roll out of the container forced by gravity. For such a purpose, the device may be parked on a ramp such that a slope on the bottom of the container may force the spherical batteries to roll out of the battery container.

The triggering of the holding or clamp mechanism may denote an activation or deactivation of the holding mechanism in the sense of a lock or release. This may happen by compressed air and/or alternatively electrically or hydraulically.

Inside the battery container, a transport mechanism may be available. In particular, rails or rolls may be used for transporting the batteries inside the inlet and outlet channel and/or within the battery container. Alternatively, the batteries may also just roll over the bottom of the battery container and the locks may apply connection forces from sides of the batteries instead from top and bottom relative to natural ground.

In the context of this description, the following conventions, terms and/or expressions may be used:

The term “battery refueling system” may denote a system, in particular inside or attached to a device or vehicle, for receiving, holding, connecting and releasing batteries.

The term “electrical device” may denote generally a device that is operable by electrical energy. The electrical energy may be delivered to the device using rechargeable batteries. In some cases, the device may be vehicle.

The term “container” or “battery container” may denote a system being adapted to be loaded with batteries. The container may be equipped with a mechanism to hold and connect the batteries to an electrical circuit. The container may have an inlet and an outlet channel.

The term “serial insertion” may denote here, in particular, a loading of batteries into a battery container, one battery after the other, i.e., serially, in a controlled and secure fashion rather than in a random way.

The term “identical shape” may denote that objects, in particular batteries, may come in similar or identical dimensions in terms of length, width and height and surface appearance.

The term “battery holder” may denote a physical arrangement to hold or fixate an object, in particular a battery. The battery may be locked in the holder in order to avoid an uncontrolled movement of the battery. The battery holder may also allow connecting the battery in a controlled way to an electrical circuit.

The term “ejection mechanism” may denote a mechanism being adapted to remove batteries from the container. It may be achieved by, e.g., compressed air or by a transportation belt.

The term “spherical shape” may denote that an object, in particular a battery, may be geometrical symmetrical as a ball. However, different areas on the surface may have different appearances and different purposes, like a connector or an isolator.

The term “half-sphere shape terminal” may denote that nearly half of the ball form shape of the surface of the sphere may be covered by an electrically conductive terminal of the battery.

The term “similar electrical properties” may denote that the batteries have comparable, in some cases identical electrical properties or that the electrical characteristics vary only slightly, e.g., have differences in characteristics below a predefined threshold value.

The term “battery” may denote a storage for electrical power or an electrochemical cell to transform chemical energy into electricity.

The term “battery loading system” may denote a system being adapted to loading batteries to an object or device, e.g., a vehicle.

The term “tube element” may denote a hollow longitudinal element typically designed to carry fluids from one location to another. Here, it may be used to carry spherically shaped objects like, e.g., batteries with a predetermined size, e.g., a tennis-ball size.

The term “container for batteries” may denote a storage container for storing objects, e.g., batteries. The batteries may be charged or discharged or partially discharged.

The proposed battery system, the battery, the battery loading system and the related method may offer a couple of advantages:

The proposed battery system may overcome currently known disadvantages of existing system. The substantially identical shape of the batteries makes it possible to put the batteries into a container of a device like bulk cargo or bulk commodities. The batteries may be loaded into the battery container, which may be part of a vehicle, in a similar way to fueling a car with gasoline using a tube element or pipe and connect it to the device or vehicle. The batteries may then serially be inserted into the battery container—equivalent to the gas tank in traditional gasoline systems. The batteries may be locked and connected to the electrical system of the device or the vehicle.

The time used for loading may be equivalent to refuel a car with regular gasoline. Discharged batteries may be removed from the container also in a serial way: either by pressing the discharged batteries with compressed air through the same tube element, or unloading the discharged batteries via a separate outlet channel.

No large and heavy battery packs may need to be exchanged. Instead, relatively small spherical batteries may be loaded to the device in a very similar manner when compared to an ordinary car refuel using gasoline. Existing infrastructure may be used—like the gas stations—and discharged batteries may be tested and inspected individually for another charge cycle.

A degree of design freedom is provided because vehicle may not have to be designed for relatively large battery packs, e.g., having the size of several suitcases. Many design alternatives may be possible because the design of the battery container is not limited by such large battery dimensions. The battery container may have separate segments, e.g., side by side, one on top of the other, round like a snail, or any other shape into which spherical or round-to-all-sides batteries may be rolled into. In a nutshell, all disadvantages of relatively large battery packs may be eliminated.

Additionally, loading newly charged batteries into a vehicle does not mean that all available batteries slots in the battery container may have to be loaded. Only a partial loading of the battery container may be possible. This advantage can be achieved by putting relatively small batteries into a device or vehicle.

Moreover, older batteries with several recharge cycles having a different electrical capacity compared to new batteries may be loaded in a mixed mode into the battery container. Electronic in-car systems may compensate such differences. The same may apply to batteries of different electrical capacity. The batteries do not have to have the same electrical capacities. Batteries having different electrical capacities may be mixed. Electronic components and systems as part of the device may compensate that.

According to one embodiment of the battery system the batteries may have a spherical shape. This may allow for an easier transportation via a tube element into a container. The batteries may be treated as bulk good. Also removing may be performed this way. A higher degree of design freedom may be related to the spherical design of the batteries as outlined above.

According to an enhanced embodiment of the battery system, the batteries may have two half-sphere shaped terminals arranged, e.g., opposite to each other with an isolator between the half-sphere shaped terminals. In particular, the terminals may be positioned on opposite sides of the sphere or ball-like design. In-between the half-sphere shaped terminals, an isolator may be positioned such that the terminals are not connected to each other.

Additionally, according to one embodiment of the battery system, the batteries may also have similar—in particular, identical—electrical properties. This may make the treatment in a refueling and recharging system easier.

According to one special embodiment of the battery system, the holding or clamp mechanism may comprise several locks. Each lock may comprise several areas or jaws. This may allow for an automatic polarity recognition and connection of the spherical batteries to electrical circuits of the device as will be explained below in the context of the figures.

In one embodiment of the battery system, the holding mechanism may be triggered—meaning activated or deactivated—by a pulse or pulses of compressed air. Alternatively, or in addition an electrical or hydraulic system may be used. This may use less energy and the compressed air used for pushing the spherical batteries into the battery container may also be used for operating the locks of the holding mechanism. Thus, also without electrical energy inside the device, the loading and unloading process may be performed.

In one enhanced embodiment of the battery system, the battery container may comprise more than one segment, such segment being a subunit of the battery container comprising a subset of the totality of batteries loaded to the battery container. It may allow for a larger degree of design freedom of the battery container and related devices. The container and/or devices—e.g., electrical vehicles—may not be just designed around a relatively bulky one-piece battery.

The battery system may also comprise a transport mechanism for the batteries which may have been inserted. This may, e.g., be rails or rolls for transporting the batteries. Alternatively, the batteries may roll on the bottom of the battery container.

In the battery system, each lock may have several areas—in particular jaws—and a sensor for detecting which terminal of a battery—in particular, the plus or minus terminal—its electrical contact areas may be connected to. This may allow for an easier connection of the batteries to other electrical circuitry, e.g., in the device. There may be no need to adjust the batteries into a certain position. Any position will do due to the spherical symmetry of the batteries.

According to one advanced embodiment of the battery system, the ejection mechanism may comprise a tube element or tube adapted for loading and/or unloading the battery container with batteries. They may be achieved by one or two nozzles attached to the tube element. Consequently, the tube element may have be single or double tube element, for loading and unloading, respectively. This mechanism may allow for an easier unloading and loading, i.e., fueling process, of batteries to a device.

Moreover, the one embodiment of the battery loading system may comprise a recognition device, such as an optical recognition device, e.g., a video camera, for identifying a socket attached to the device to connect the tube element to. This may be a foundation for a completely automated battery loading. The video camera may recognize a socket at the device which may be connected to the battery container. A nozzle of the tube element may be moved, e.g., a tube element handling system, e.g., robot system, to the inlet channel of the container and automated unloading and loading—i.e. refueling—may start and be operated automatically.

It should also be noted that embodiments of the invention have been described with reference to different subject-matters. In particular, some embodiments have been described with reference to method type claims whereas other embodiments have been described with reference to apparatus type claims. However, a person skilled in the art will gather from the above and the following description that, unless otherwise notified, in addition to any combination of features belonging to one type of subject-matter, also any combination between features relating to different subject-matters, in particular, between features of the method type claims, and features of the apparatus type claims, is considered as to be disclosed within this document.

The aspects defined above and further aspects of the present invention are apparent from the examples of embodiments to be described hereinafter and are explained with reference to the examples of embodiments, but to which the invention is not limited.

In the following, a detailed description of the figures will be given. All instructions in the figures are schematic. Firstly, a block diagram of an embodiment of the inventive battery system is given. Afterwards, embodiments of the battery, a device with inlet and outlet channel, the battery loading system, and a method for refueling an electrical device will be described.

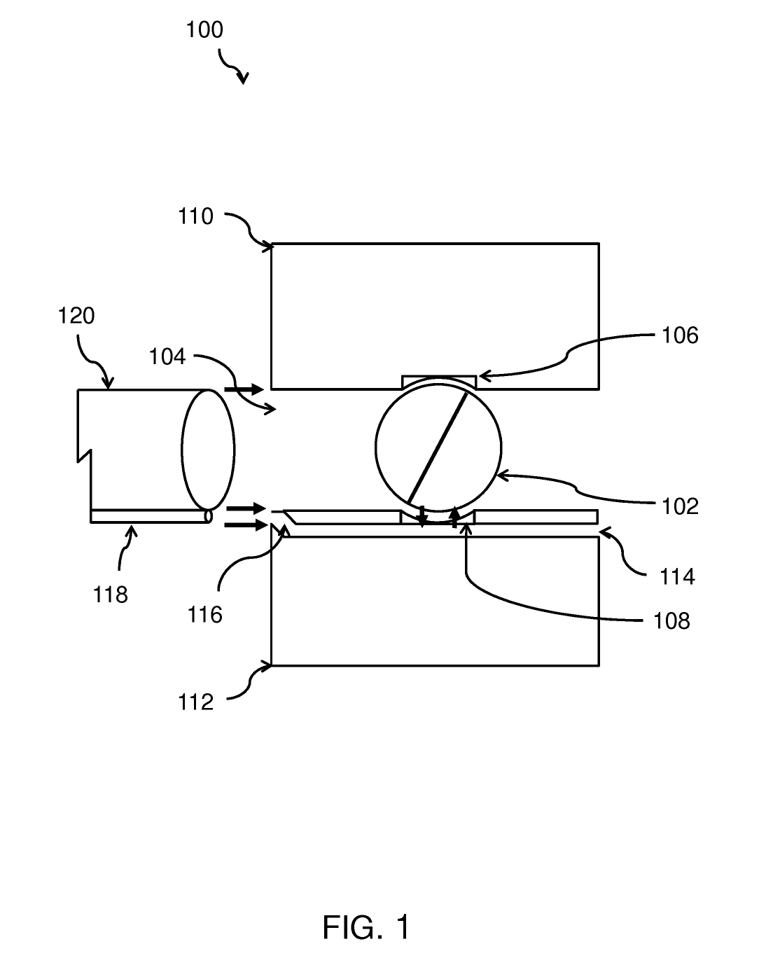

FIG. 1 shows a block diagram of an embodiment of the battery system 100 for an electrical device. Multiple batteries 102 may be serially inserted via an inlet channel 104. The batteries 102 may have an identical shape. A battery container 203 is only shown in part. Walls 110, 112 may represent parts of walls of the battery container 203 for the batteries 102. One such battery container 203 may be loaded with multiple batteries 102.

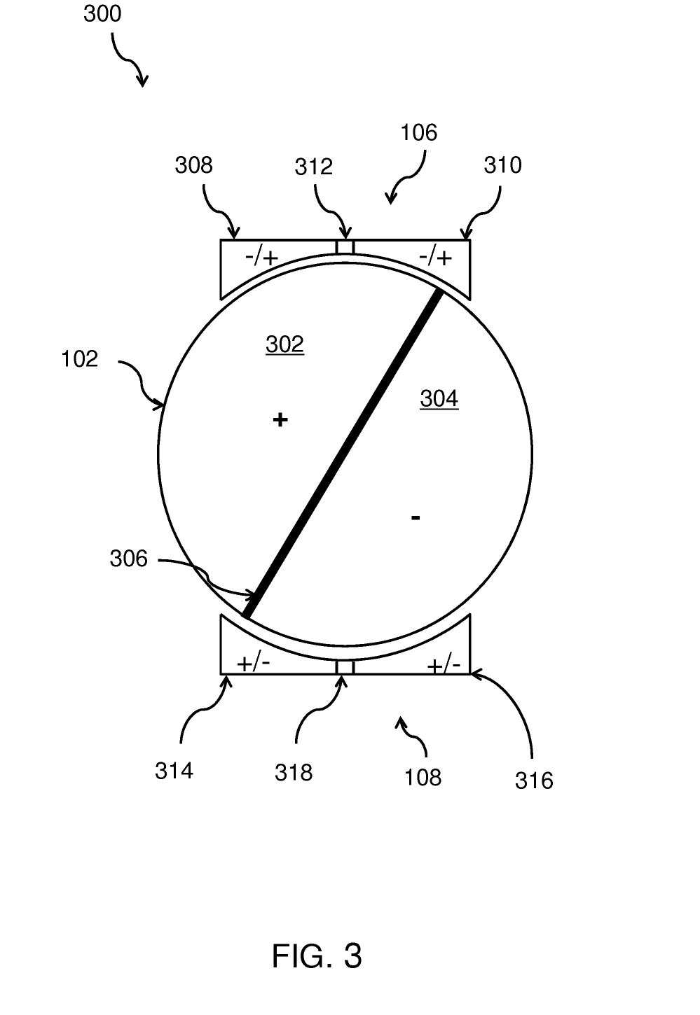

Each of the inserted batteries 102 may be held by a holding mechanism comprising a pair of battery holders 106, 108. This may imply that multiple pairs of batteries holders 106, 108 may be arranged. However, not every battery holder 106, 108 requires to hold a battery 102. The battery container 203 may only be partially loaded. The holding mechanism may be operable by applying an operation trigger to selectively hold the inserted batteries 102. For each of the battery holders 106, 108 electrical connectors (compare FIG. 3) for connecting the inserted batteries 102 are available. Thereby a connection may be made to an electrical circuitry of the device. The batteries 102 may be ejected via an outlet channel in a serial fashion for security and control reasons. There may also be an ejection mechanism to eject the batteries 102 via the outlet channel in a serial fashion. The ejection mechanism may be operated by compressed air and/or by gravity, e.g. on a ramp if the vehicle may be on a ramp, and/or other forces.

The batteries 102 may be loaded into the battery container 203 through a tube element 120. It may physically be connected to the inlet channel 104. A fluid supply tube element 118 may allow blowing compressed air into a channel 116. At one end 114 of the channel 116 the compressed air may be led to a next battery holder in the battery container 203. Batteries 102 and battery holders 106, 108 may be arranged in series and relatively close to each other. The distance between two adjacent batteries 102 can be made at least or just large enough to separate them physically such that no direct electrical contact between two batteries 102 may be possible.

It may also be noted that the batteries 102 may be user commodity storage for electrical power. The batteries 102 may be transported to wind energy stations or solar fields and may be charged with newly generated electrical energy. These charged batteries 102 may be carried to refueling stations like today's typical gas stations. This may eliminate the need for high power cables, usually required for refueling stations.

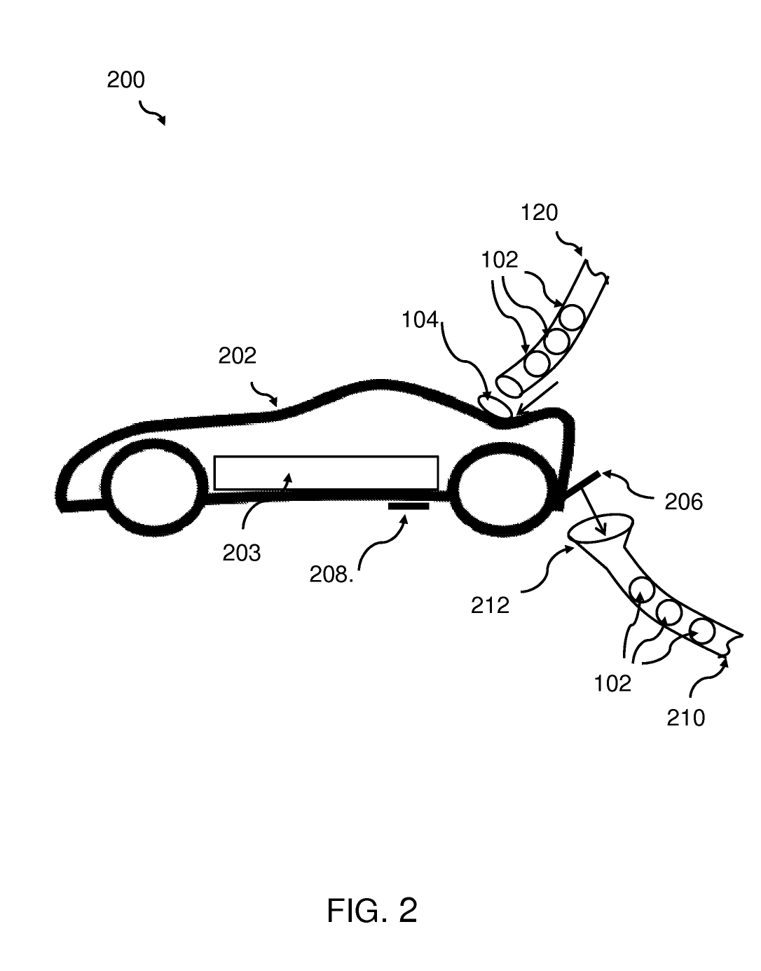

FIG. 2 shows a block diagram 200 of an embodiment of a device 202 with an inlet channel 104 and an outlet channel 206. Batteries 102 may be loaded via the tube element 120 into the inlet channel 104 to be loaded to the battery container 203 inside or attached to a device 202, such as a car. There may be design freedom regarding the position of the inlet channel 104 and outlet channel 206 as well as the battery container 203. Using compressed air for pushing the batteries 102 into the battery container 203 or pushing them out of the battery container 203 may allow also a pushing of the batteries 102 uphill inside the battery container 203 or related transport mechanisms channels from inlet and outlet channel 104, 206 to the battery container 203. The batteries 102 may be removed from the device 202 via outlet channel 206 and tube element 210. For an easier handling a funnel may be attached to the tube element 210.

In an alternative embodiment, the inlet channel 104 and the outlet channel 206 may be of unitary construction. The batteries 102 to be unloaded may be dispensed serially through the same tube element 120 that may also be used for loading the batteries 102 into the battery container 203.

In another embodiment, the outlet channel 206 may end at a door or flap 208 at the bottom of the device 202. The device 202 may be positioned on a ramp such that the bottom of the container 203 may be inclined if compared to a natural horizontal position, such that the batteries 102 may roll out of the container 203 by the force of gravity. However, compressed air may also help here to control the unloading process. Alternatively, the battery container 203 may be positioned inside the device 202 in a way such that the batteries 102 may roll naturally out of the battery container 203. The battery container 203 may be inclined if compared to a horizontal natural ground level. The funnel 212 may ensure that discharged batteries 102 may leave the device 202 or battery container 203 in a controlled manner. Alternatively, a funnel may be integrated in an area below an unloading area where the device 202 may be parked. The batteries 102 may just fall to the ground—e.g., on damping material—and roll into a collection funnel to be transported to a recycling station.

It may be noted that the device 202 may be—but is not limited to—an electrically driven vehicle or car. However, also e-trucks, e-bikes, golf cars, lawn mowers, forklifts, e-boats e-planes, e-helicopters and many other electrically powered devices may be loaded with the spherical batteries. In this sense, the e.g., spherical batteries 102 may be seen as a replacement for liquid fuel. The existing infrastructure of fuel stations and the delivery of energy via truck may be used. No new infrastructure may be required to change from a gas centric transportation management to an electric power centric system.

The battery container 203 may be constructed in a flexible way. It may be designed in a winding form filling empty spaces in the vehicle. The inlet channel 104 may, e.g., be positioned at a relative high point in, e.g., the C-pillar of the vehicle 202. The battery container 203 may begin just behind the inlet channel 104 and may wind through cavities or hollow space of the vehicle, e.g., below and behind seats, under doors or the dashboard or any other, already available hollow spaces in the vehicle 202. Differently sized batteries 102 may be designed for different kind of vehicles 202; e.g., larger ones for e-trucks and smaller ones for lawn movers or sports cars.

The batteries 102 may roll through the force of gravity into their positions; compressed air may support that process.

In case of an e-bike or e-scooter, the battery container 203 may be positioned inside the frame of the vehicle. Thus, a flexible design is possible using spherical batteries 102.

FIG. 3 shows a block diagram 300 of an embodiment of a spherical battery 102 with a holding mechanism. The battery 102 may have a spherical shape, like a ball. A tennis ball or a golf ball may be a typical size of the spherically shaped battery 102. Generally, there are no limitations regarding the size of the battery 102. This may apply to the lower end of size and to the upper end of size depending on the battery technology.

The battery 102 may have at least two electrical terminals 302, 304, at least one plus terminal 302 and one minus terminal 304. Each of the terminals 302, 304 may have a half-sphere shape on the surface of the spherical shape. The half-sphere shaped terminals 302, 304 may be arranged opposite to each other on the surface of the spherical shape of the battery 102. The two half-sphere shaped terminals 302, 304 may be separated from each other by an isolator 306 in the surface of the sphere. The dimension of the isolator 306 may vary depending on the size of the battery 102. It may have a dimension that when batteries 102 may roll serially in a channel, a shortcut never happens. However, the channel and/or holding mechanism could also be designed to keep the batteries 102 spaced apart so that no short circuit happens. However, more than two terminals 302, 304 for the plus pole and the minus pole are possible. The terminals 302, 304 may be organized pair-wise for “plus” and “minus” on the surface of the spherical battery 102. It may be either a quarter sphere or any other part of the spherical shape of the battery 102. Such an organization of the terminals 302, 304 may be useful for a connection of the batteries 102 to an electrical circuit outside the battery 102. Any other split—e.g. horizontal, diagonal, circle-wise—may be allowed. This may depend on the holding mechanism for the battery 102 used. Thus, the terminals 302, 304 may have a number of elements each, e.g., two, four, six, eight, ten or the like.

An example for a connection mechanism may be described here: A battery holder 106, 108 may comprise each several jaws 308, 310 and 314, 316. They may be designed to pair-wise and cross-wise clamp the battery 102 between them. If it may be detected that e.g., jaw 310 may cause a shortcut between two terminals 302, 304 of the battery 102, then jaw 308 would be used for the jaw component on one side of the holder element 106. Consequently, jaw 316 would be used as a second clamp element on another side of the battery 102. The jaws 308, 310, 314, 316 may be movable in a vertical direction towards the battery 102, in the context of FIG. 3. However, the orientation may also be left to right or any other direction which with respect to the battery 102. Because the battery is substantially round any orientation may be possible. In-between a pair of jaws 308, 310 or 314, 316, there may be an isolating element 312, 318, respectively. This way, it may be guaranteed, that the battery 102 may be held safely and secure, and that a connection may be established to electrical contacts.

The lock may comprise at least two electrical contact areas that get into contact with the terminals 302, 304 such that the battery voltage is usable to provide power to an electrical circuitry. Furthermore, the lock may comprise a sensor for detecting which of the terminals 302, 304 of the battery 102 its electrical contact areas are in contact with.

No shortcut should be provoked when connecting the battery holder. A relatively fast and easy locking and releasing of the batteries 102 may be achieved. The battery holders 106, 108 may be activated or deactivated by force such as compressed air. Alternatively, they may also be operated electrically or hydraulically.

Because each battery 102 may be held and clamped individually, it may not be required to load a battery container in the vehicle 202 completely with batteries 102. The battery container 203 holding the batteries 102 could only be partially loaded for the device 202 to be operated. An electric/electronic circuitry may switch the batteries 102 in such a way that a desired voltage may be reached. However, in case of a partial load, the total capacity may be lower if compared to a fully loaded battery container 302.

In an enhanced embodiment of the battery 102, it may also comprise an electronic cycle counter, e.g., in an RFID tag (not shown) as part of the battery 102 for counting the charging cycles of the battery 102. This may enhance stability of quality of the batteries 102 in use. Moreover, the RFID tag may also comprise an identification code of the battery 102. This way, a life cycle of the battery 102 may be controlled. Also other battery and environmental characteristics may be stored in such an RFID tag, e.g., a manufacturer ID, the time of manufacturing, total expected cycle times, remaining expected cycle time, etc.

The battery 102 may also comprise an electronic circuit that may allow deactivating the battery 102 during a refueling or loading/unloading process. This may avoid shortcuts if several batteries 102 roll side by side and touch each other with their terminals 302, 304,. In another embodiment, it may be possible to have cylindrical batteries 102 and apply any other system presented herein for shortcut avoidance in a comparable way, in accordance with the know-how of a skilled person.

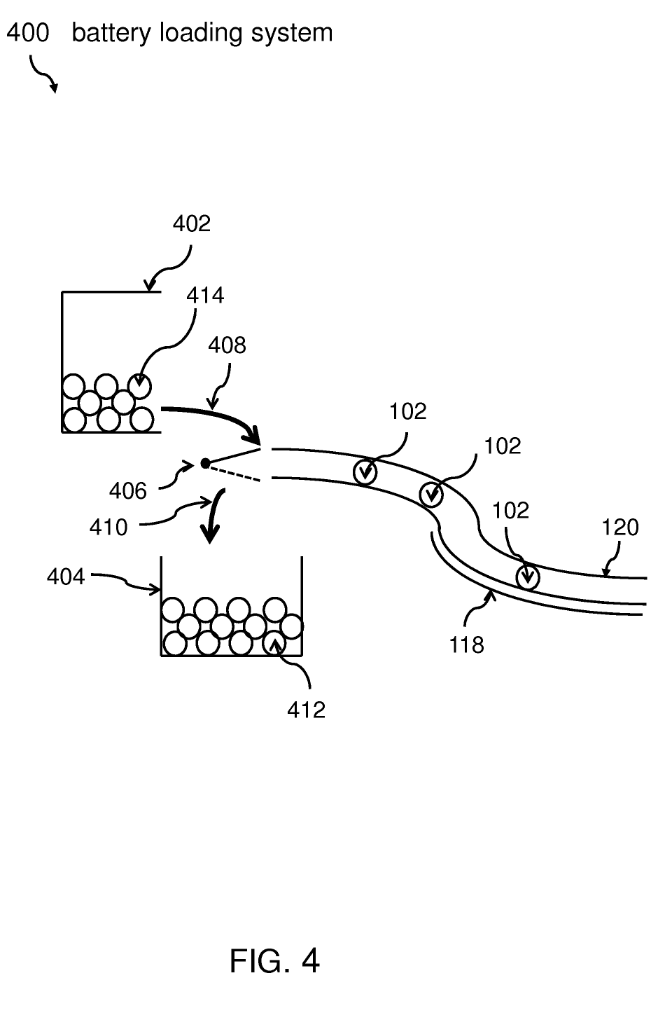

FIG. 4 shows a block diagram of an embodiment of a battery loading system 400 for spherical batteries 102. The battery loading system 400 may be viewed as an equivalent to a gasoline pump if the vehicle would use gasoline instead of batteries. A tube element 120—such as a hose or a pipe, in particular, a flexible pipe, which may also be robot operated—may have an inner diameter corresponding to the diameter of the spherical batteries 102.

There may also be a fluid supply tube element 118 connected to the tube element 120. It may be used to conduct compressed air. One end of the tube element 120 may be connected to a device 202 such as an electrical vehicle, to load the vehicle with batteries 102 (aspect not shown in FIG. 4).

The tube element 120 may also be used to unload the battery container 203 in the vehicle 202. In that case the batteries 102 would move from the right to the left side of the tube element 120 in FIG. 4 and come to a vent 406. The position of the vent 406 may direct the batteries 102—which most likely may be electrically discharged—to a second container 404 for receiving the batteries 412. For loading charged batteries 414 through the tube element 120 to the device 202—and more particularly, to the battery container 203 in the device 202—the vent 406 may direct the batteries 414 from a first container 402 for the batteries 102 to the tube element 120 into the direction of a battery dispenser (not shown) at the vehicle-sided end of the tube element 120. The battery dispenser may be comparable to a gas pump nozzle in case of gasoline. Thus, the vent 406 may give selectively way for the charged batteries 414 or the discharged batteries 412 as indicated by arrows 408 and 410.

It may be noted that precautions may be taken that the batteries in the containers 402, 404 do not touch each other because this may cause shortcuts. In another embodiment, the containers 402 and 404 may comprise an apparatus to charge the discharged batteries 412.

Moreover, in case two tube elements 120 are used—one for unloading and one for loading, a double nozzle may be used. A bayonet connector may be used to fix the tube element 120 and/or the nozzle to the device 202 or vehicle.

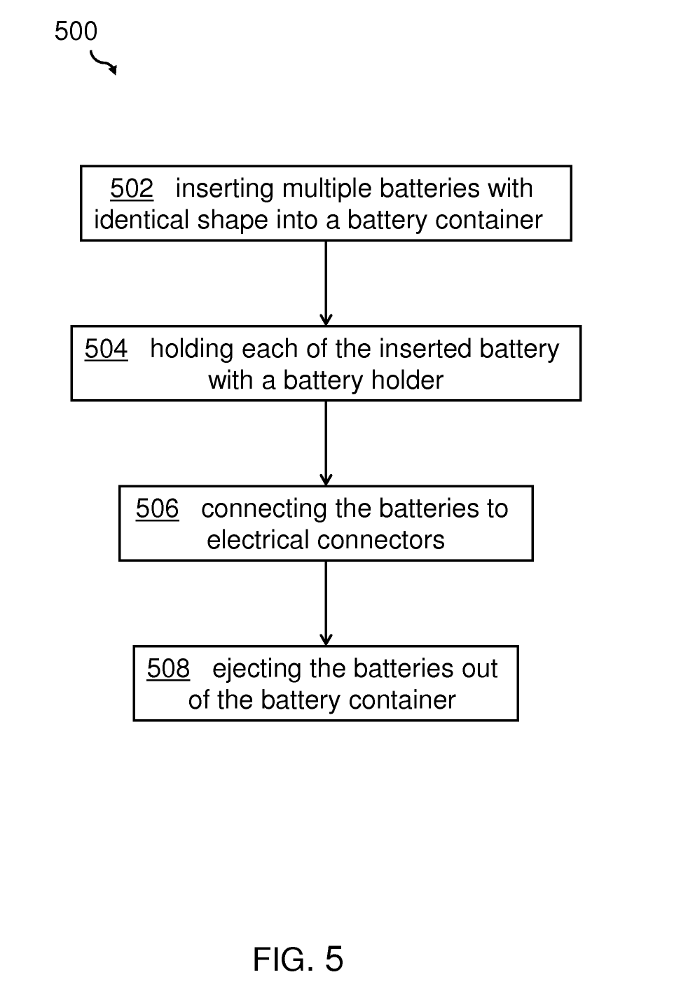

FIG. 5 shows an embodiment of the method 500 for loading an electrical device 202 with batteries. The method 500 for loading an electrical device with batteries may comprise: inserting 502 multiple batteries with substantially identical shape into a battery container. The battery container may comprise an inlet channel for a serial insertion of multiple batteries.

The method may also comprise selectively holding 504 each of the inserted batteries with a battery holder. The battery holder may comprise a holding mechanism that may be operable by applying an operation trigger, and connecting 506 the inserted batteries to electrical connectors. Thereafter, the method may comprise ejecting 508 the batteries out of the battery container through an outlet channel.

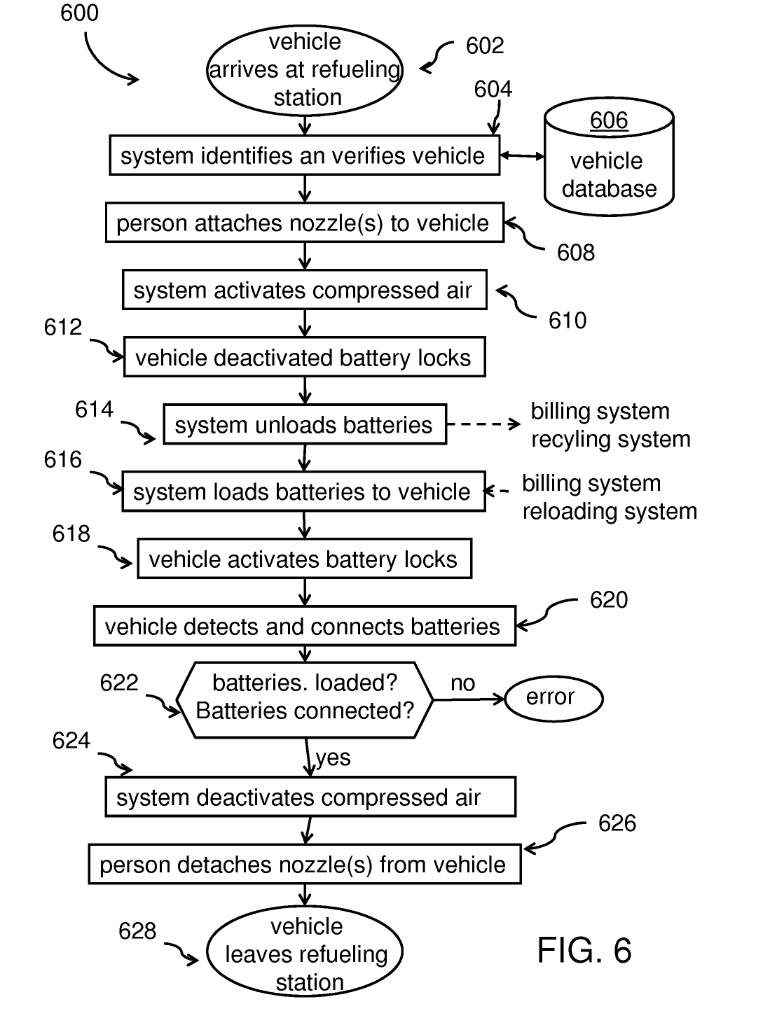

FIG. 6 shows a flow chart 600 of activities performed if a vehicle may be “refueled” or re-equipped or loaded with batteries. Individual steps comprise:

602—The vehicle arrives at the loading station.

604—The system identifies the vehicle. A check for the identity of the vehicle may be performed using a vehicle database 606.

608—A person attaches a nozzle(s) to the vehicle.

610—The system activates compressed air for use during the unloading/loading process.

612—The vehicle deactivates battery locks.

614—The system unloads discharged (or damaged, or aged or otherwise unwanted) batteries. A communication with a billing system may be performed. The batteries may be moved to a recycling system.

616—The system loads charged batteries into the vehicle.

618—The vehicle activates battery holders.

620—The vehicle detects and connects batteries as described above.

622—A check is made whether the batteries loaded into the battery container are connected. In case of “yes”,

624—The system deactivates the compressed air—otherwise an error message is signaled optically and/or acoustically.

626—A person detaches the nozzle(s) from the vehicle.

628—The vehicle is ready to leave the loading station.

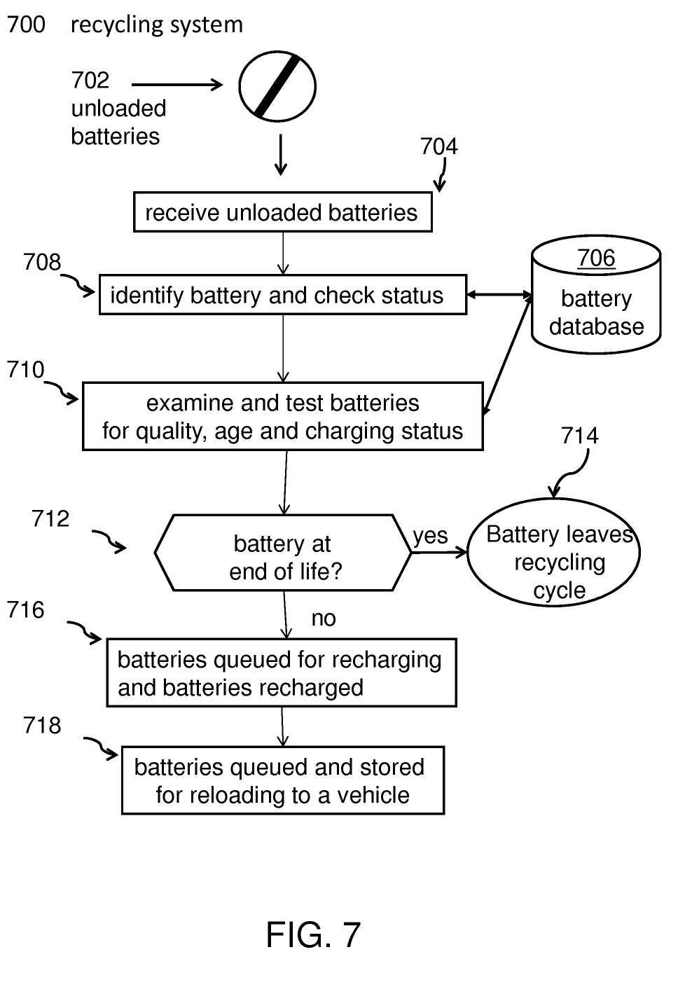

FIG. 7 shows an exemplary flowchart 700 for a recycle system for the batteries. Unloaded batteries 702 from a vehicle are received at a recycle station. Alternatively, it may also be batteries from the second container (404, FIG. 4) where the unloaded batteries may have been an intermediate stored. Several steps may be performed for recycling of the batteries:

704—The batteries are received at the recycling station.

708—The batteries may be tested for identity and physical status, e.g., physical damage. A video system for image recognition and a battery database 706 may be used for this task. It may store life-cycle data of each battery. The database may be station specific or it may be a central database for a plurality of recycling stations. The data may also be stored in multiple databases and remotely accessible. An optional RFID tag at each battery may also store the required information. Thus, a central database may be omitted.

710—At this stage the batteries may be tested for a charge-cycle count and electrical properties as well as charging status. The battery database may also be used here.

712—Here, it may be decided that the battery may have reached its end of life to leave the recycling cycle, 714. Several reasons may be used as decision criterion: physical damage, electrical damage, low capacity, number of charging cycles, etc.

716—The batteries may be queued for recharging. A final test may also be performed after the recharging.

718—Finally, the batteries may be queued again for a reloading into a vehicle, potentially a different vehicle than the one the batteries have been unloaded from. The batteries may be transported to the first container for intermediate storage (402, FIG. 4)

There may also be connections to a billing system (not shown). Users of the vehicles or devices may have to pay for the use of electrical power in the batteries.

One connection may be established from the unloading task (614, FIG. 6) to the billing system. The number of batteries unloaded may be one parameter for the billing system for monetary charging. Another parameter may be seen in the number of batteries that may be loaded into the vehicle during the battery loading process. One additional parameter for the billing system may be the electrical charging status of the unloaded batteries. Not completely depleted batteries still have some charge left. Thus, a user may not pay for the electrical energy delivered back to the refueling stations in form of not completely discharged batteries.

One other input parameter for the billing system may be the number of batteries loaded into the battery container of the device. It may be noted that is may not be required to load the device completely with new batteries. Also a partial physical loading may be possible. Again another parameter for the billing system may be the amount of electrical power stored in the batteries that may be loaded into the batteries container of a device.

A skilled person will directly notice even more data exchange points of the subject-matter of the elements and systems disclosed here to a billing system.

While the invention has been described with respect to a limited number of embodiments, those skilled in the art, having benefit of this disclosure, will appreciate that other embodiments may be devised, which do not depart from the scope of the invention, as disclosed herein. Accordingly, the scope of the invention should be limited only by the attached claims. Also, elements described in association with different embodiments may be combined. It should also be noted that reference signs in the claims should not be construed as limiting elements.

The block diagrams in the Figures illustrate the architecture, functionality, and operation of possible implementations of systems, methods and optionally computer program products according to various embodiments of the present disclosure. In this regard, each block in the block diagrams may represent a module, segment, or portion of code, which comprises one or more executable instructions for implementing the specified logical function(s). It should also be noted that, in some alternative implementations, the functions discussed hereinabove may occur out of the disclosed order. For example, two functions taught in succession may, in fact, be executed substantially concurrently, or the functions may sometimes be executed in the reverse order, depending upon the functionality involved. It will also be noted that each block of the block diagrams, and combinations of blocks in the block diagrams, may be implemented by special purpose hardware-based systems that perform the specified functions or acts, or combinations of special purpose hardware and computer instructions.

The terminology used herein is for the purpose of describing particular embodiments only and is not intended to limit of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or steps plus function elements in the claims below are intended to include any structure, material, or act for performing the function in combination with other claimed elements, as specifically claimed. The description of the present invention has been presented for purposes of illustration and description, but is not intended to be exhaustive or limited to the invention in the form disclosed. Many modifications and variations will be apparent to those of ordinary skills in the art without departing from the scope and spirit of the invention. The embodiment was chosen and described in order to best explain the principles of the invention and the practical application, and to enable others of ordinary skills in the art to understand the invention for various embodiments with various modifications, as are suited to the particular use contemplated.

What is claimed is:

1. A method for loading a battery container with batteries, the method comprising:
serially inserting multiple batteries with substantially identical shape into said battery container via an inlet channel:,
selectively holding each of the inserted batteries with a battery holder which comprises a holding mechanism that is operable by applying an operation trigger;
connecting the inserted batteries to electrical connectors; and
ejecting the batteries out of the battery container through an outlet channel.
